(19) United States
(12) Patent Application Publication
(10) Pub. No.: US 2003/0068470 A1
(43) Pub. Date: Apr. 10, 2003

(54) Combination of imaging member and functional base for new utility

(75) Inventors: Robert P. Bourdelais, Pittsford, NY (US); Timothy J. Giarrusso, Rochester, NY (US); Philip J. Smith, Webster, NY (US)

Correspondence Address: Paul A. Leipold, Patent Legal Staff, Eastman Kodak Company, 343 State Street, Rochester, NY, 14650-2201, US

(73) Assignee: Eastman Kodak Company

(21) Appl. No.: 09/932,624

(22) Filed: Aug. 17, 2001

(51) Int. Cl. B32B 3/30

(52) U.S. Cl. 428/156; 428/195

(57) ABSTRACT

The invention relates to an article comprising an image member comprising a polymer sheet having an image adhered thereto permanently adhered to a functional base wherein said image member and said functional base interact to create a new image utility and wherein said polymer sheet has a thickness of less than 250 micrometers.

### FIELD OF THE INVENTION

This invention relates to imaging display materials. In a preferred form it relates to base and imaging layers for commercial display.

### BACKGROUND OF THE INVENTION

It is known in the art that photographic display materials are utilized for advertising as well as decorative displays of photographic images. Since these display materials are used in advertising, the image quality of the display material is critical in expressing the quality message of the product or service being advertised. Further, a photographic display image needs to be high impact, as it attempts to draw consumer attention to the display material and the desired message being conveyed. Typical applications for display material include product and service advertising in public places such as airports, buses and sports stadiums, movie posters and fine art photography. The desired attributes of a quality, high impact photographic display material are a slight blue density minimum, durability, sharpness and flatness. Cost is also an important consideration as display materials tend to be expensive compared with alternative display material technology mainly lithographic images on paper. For display materials, traditional color paper is undesirable as it suffers from a lack of durability for the handling, photoprocessing and display of large format images.

Prior art photographic reflective display materials have light sensitive silver halide emulsions coated directly onto a gelatin coated on an opaque polyester base sheet. Since the emulsion does not contain any materials to opacify the imaging element, white pigments such as BaSO₄ have been added to the polyester base sheet to provide a imaging element with both opacity and the desired reflection properties. Also, optical brighteners are added to the polyester base sheet to give the sheet a blue tint in the presence of a ultraviolet light source. The addition of the white pigments into the polyester sheet causes several manufacturing problems which can either reduce manufacturing efficiency or reduce image quality. The addition of white pigment to the polyester base causes manufacturing problems such as die lines and pigment agglomeration which reduce the efficiency at which photographic display material can be manufactured.

Prior art reflective photographic materials with a polyester base use a TiO₂ pigmented polyester base onto which light sensitive silver halide emulsions are coated. It has been proposed in WO 94/04961 to use an opaque polyester containing 10% to 25% TiO₂ for a photographic support. The TiO₂ in the polyester gives the reflective display materials an undesirable opalescent appearance. The TiO₂ pigmented polyester also is expensive because the TiO₂ must be dispersed into the entire thickness, typically from 100 to 180 micrometers. This also gives the polyester support a slight yellow tint which is undesirable for a photographic display material. For use as a photographic display material, the polyester support containing TiO₂ must be tinted blue to offset the yellow tint of the polyester causing a loss in desirable whiteness and adding cost to the display material. It would be desirable if a reflective display support did not contain any TiO₂ in the base and TiO₂ could be concentrated near the light sensitive emulsion.

U.S. Pat. Nos. 5,327,201 and 5,337,132 granted to Robert E. Coleman on Jul. 5, 1994 and to Abraham Cherian on Aug. 9, 1994, respectively, disclose the creation of simulated photographic prints using xerography. To this end, reverse reading images are formed on a transparent substrate and a backing sheet is adhered to the transparent substrate.

Protective sheets used in various printing and imaging processes are well known. For example, U.S. Pat. No. 5,418,208 (Takeda and Kawashima) discloses a laminated plastic card providing a lamination of a dye accepting layer, a substrate of paper or the like, and a back coat layer on which lamination one or more patterns are printed with a volatile dye, and a transparent plastic film adhered on the lamination by an adhesive agent, wherein the adhesive agent is a saturated polyester having an average molecular weight of 18,000 gm/mole and produced by condensation polymerization of polypropylene glycol or trimethylol propane and adipic acid or azelaic acid.

U.S. Pat. No. 5,413,840 (Mizuno) discloses a decorative laminated sheet having a sense of being coated and having improved surface hardness, which is produced by laminating a polyester film excellent in transparency on the surface of a semi-rigid thermoplastic resin film supplied with a colored layer or a pattern-printed layer, and then coating a hard coat layer comprising a UV-curable coating on the surface of the polyester film of the resulting laminated film, and a process for producing the same. This invention can provide a sheet not only excellent in scratch resistance, specular reflectivity and sharpness of the surface, but having a sense of being deeply coated as well.

U.S. Pat. No. 5,352,530 (Tanuma et. al) discloses a highly transparent film having high strength, suitable extensibility, high weather resistance, low moisture absorption, which consists mainly of ethylene-vinylacetate copolymer. Various laminates making the most of the above properties of the film are disclosed, which comprise the ethylene-vinylacetate copolymer interposed between two inorganic material sheets, two organic material sheets, or an inorganic material sheet and an organic material sheet.

U.S. Pat. No. 5,346,766 (Otter and Watts) discloses a positionable-repositionable pressure sensitive adhesive that may be repeatedly applied to a surface and removed during an initial installation time period. The adhesive contains an adhesive base resin and coacting detackifying resin and particulate components which temporarily reduce the tack and peel strength of the adhesive. Upon passage of time and/or application of thermal energy, adhesion build-up occurs to a maximum value. The pressure-sensitive adhesive may be used as an adhesive layer in a laminate for tapes, # signs and decorative and protective applications including vehicle marking and architectural installations.

Simulated photographic-quality prints are created using non-photographic imaging such as xerography and inkjet printing are disclosed in U.S. Pat. No. 5,906,905. In U.S. Pat. No. 5,906,905 reverse reading toner images are formed on a transparent substrate which is adhered to a coated backing sheet. The backing sheet is coated with a lightfastness material for minimizing degradation of color images exposed to UV light.

In U.S. Pat. No. 6,030,756 (Bourdelais et al), a polyester base laminated with a translucent biaxially oriented polyolefin sheet is proposed as a display material that can function in the day and night. The imaging layers in U.S. Pat. No. 6,030,756 are coated and printed in registration for both the front side and the backside of the support.

In U.S. Pat. No. 6,017,685 (Bourdelais et al), a polyester base laminated with a translucent biaxially oriented polyolefin sheet is proposed for a transmission display material. The base material in U.S. Pat. No. 6,017,685 contains all of the optical and physical properties required to function as a transmission display material.

In the commercial display market, imaging support materials that have improved optical properties, mechanical properties and textured properties over polyester base materials or polyester and polyolefin base materials have significant commercial value. The number of differentiated display materials tend to be limited as there are several complexities in the manufacturing and the image creation step which need to be overcome. Examples of manufacturing and image creation complexities which have limited the variety of support materials include web conveyance in manufacturing, imaging layer adhesion, photographic reactivity, conveyance in printers, and unwanted interaction with processing chemistry.

### PROBLEM TO BE SOLVED BY THE INVENTION

There is a need for improved display material bases having improved optical, mechanical and texture properties while reducing the complexities of manufacturing, printing, image preparation, and displaying images.

### SUMMARY OF THE INVENTION

It is an object of the invention to overcome disadvantages of prior display materials.

It is another object to provide display materials having improved optical, mechanical and texture features.

It is a further object to reduce the manufacturing and printing complexity of new support materials.

These and other objects of the invention are accomplished by an article comprising an image member comprising a polymer sheet having an image adhered thereto permanently adhered to a functional base wherein said image member and said functional base interact to create a new image utility and wherein said polymer sheet has a thickness of less than 250 micrometers.

### BRIEF DESCRIPTION OF THE DRAWINGS

FIG. 1 is an illustration of the structure of a thin polymer sheet imaged with silver halide adhesively adhered to an electroluminescent base.

### DETAILED DESCRIPTION OF THE INVENTION

The invention has numerous advantages over prior practices in the art. The display materials of the invention can be differentiated by utilizing a wide range of functional base materials which are difficult to coat with imaging layers and difficult to print in existing printing equipment. By allowing differentiated function base materials to be utilized, the commercial display material can significantly improve the quality and consumer retention of advertising message. An example is rigid foam board. Foam rigid board used for mounting and displaying images typically is 1.5 cm thick and has a stiffness over 2,000 millinewtons. Because the coating and printing of silver halide imaging layers on conventional equipment requires a flexible web material with a stiffness less than 350 millinewtons, it would be difficult to coat and print silver halide imaging layers applied to foam board. The invention materials remove the complexity of attempting to coat and print foam board and allows silver halide imaging layers to be applied to rigid foam board. The invention allows the use of optical enhancements to the image, further providing improvements that allow the image to attract the attention of the consumer.

The invention materials allow commercial labs to synchronize the content of the image with the functional base to create a better advertising message. An example would be an advertisement for a pair of blue jeans. The texture of the denim used in the blue jeans can be made even more realistic by using a denim functional base material so that the consumer sees the blue jean image and can also connect with the texture contained in the image imparted from the denim functional base.

The invention materials further allow for composite image structures where two or more image members are used to provide a unique and value added message. An example would be a silver halide image that is over laminated with an inkjet image. The silver halide image provides excellent flesh tone and depth of image and the inkjet image provides an improved color gamut over the silver halide. The combination image uniquely provides excellent flesh tone with an expanded color gamut.

The invention also allows for a significant improvement in the efficiency of a commercial display lab as a small number of imaging members can be differentiated after the image layers have been printed. By reducing the number of printed imaging members and post printing applying the imaging member to functional base materials, inventories of imaging members can be reduced.

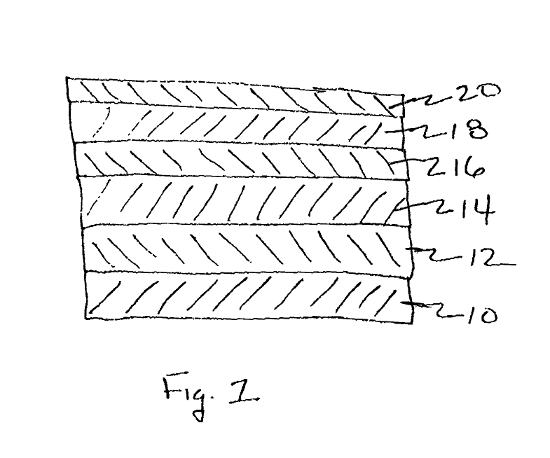

FIG. 1 is an illustration of the structure of a thin polymer sheet imaged with silver halide adhesively adhered to an electroluminescent base. The electroluminscent base comprises rear electrode 10, phosphor layer 12 and clear conductive layer 14. Adhesively adhered to the clear conductive layer 14 is pressure sensitive adhesive layer 16, thin transparent polymer layer 18 and silver halide imaged layer 20. When power is applied to the rear electrode 10, the phosphor layer 12 glows providing a rear illumination to silver halide imaged layer 20. The light energy emitting from phosphor layer 12 is transmitted through the transparent polymer layer 18 and illuminates the silver halide imaged layer 20. The article of FIG. 1 has uses for indoor commercial signage, rear illuminated photographic albums and rear illuminated labels.

The reflective display material of the invention has a whiter white than prior materials. Prior materials were somewhat yellow and had a higher minimum density as there was a large quantity of white pigment in the polymer base sheet. Typically when a large quantity of white TiO₂ is loaded into a transparent polymer sheet, it becomes somewhat yellowish rather than being the desired neutral reflective white. The prior art base sheet containing white pigment was required to be quite thick, both to carry the high amount of white pigment, as well as to provide the stiffness required for display materials. The display material of the invention provides sharper images as they have higher accutance due to the efficient reflective layer on the upper surface of the biaxially oriented polyolefin sheet. There is a visual contrast improvement in the display material of the invention as the minimum lower density is lower than prior product and the upper amount of density has been visually increased. The display material has a more maximum black as the reflective properties of the improved base are more specular than the prior materials. As the whites are whiter and the blacks are blacker, there is more range in between and, therefore, contrast is enhanced. These and other advantages will be apparent from the detailed description below.

The terms as used herein, “top”, “upper”, “emulsion side”, and “face” mean the side or toward the side of the imaging member bearing the imaging layers. The terms “bottom”, “lower side”, and “back” mean the side or toward the side of the imaging member opposite from the side bearing the imaging layers or developed image. The term as used herein, “transparent” means the ability to pass radiation without significant deviation or absorption. For this invention, “transparent” material is defined as a material that has a spectral transmission greater than 90%. For a photographic element, spectral transmission is the ratio of the transmitted power to the incident power and is expressed as a percentage as follows; T_{RGB}=10^{-D}*100 where D is the average of the red, green and blue Status A transmission density response measured by an X-Rite model 310 (or comparable) photographic transmission densitometer.

In order to remove the complexity of using differentiated base materials in existing manufacturing and printing equipment an article comprising an image member comprising a polymer sheet having an image adhered thereto permanently adhered to a functional base wherein said image member and said functional base interact to create a new image utility and wherein said polymer sheet has a thickness of less than 250 micrometers is preferred. By providing a thin polymer containing an imaging layer adhered to a functional base, the imaging layers can be, after printing, adhered to functional bases which would be difficult to transport through manufacturing and printing. Further, several imaging layers on a thin polymer sheet can be used in combination to allow, for example, an inkjet image to be used with a silver halide image combining the best of each imaging technology to provide a superior display image for advertising.

A new image utility that comprises a textured surface is preferred. Textured surfaces are preferred in that they provide softness to an image and reduce the gloss of the image. By adhering the thin imaging member to a functional base containing texture, the polymer sheet and the image will replicate the texture of the functional base. An example would be a imaging member adhered to an embossed aluminum web material. The imaging member would have a similar texture to the embossed aluminum web.

In another embodiment of the invention, a new image utility that comprises an optically enhanced image is preferred. Optically enhanced images can provide a clearer, sharper image and can provide a unique look that has significant commercial value. By adhering the thin image member to a functional base material, the appearance of the image can be changed to provide a pleasing, eye catching image. An example would be a translucent image member adhered to a electroluminescent functional base. Applying a voltage to the electroluminescent functional base, the imaging member can be illuminated from the backside eliminating the need for a light box as an illumination source. Electroluminescent functional bases are constructed of a layered material that when assembled with a power supply, produce light. An electroluminescent power coating, typically phosphor, is positioned between two electrode layers. One electrode is opaque and the other is transparent. When the electroluminescent functional base is connected to an electrical current, typically a 280VAC/650 Hz supply, the powder glows, providing cool, uniform, backlighting for images.

In another embodiment of the invention, a new image utility comprising a structurally stronger image is preferred. An image on a base material that is structurally strong is preferred as display materials frequently are repeatedly hung and displayed in trade shows. A strong functional base material allows for an extended life for of the image and will be more curl resistant that images on bases that are thin. Examples of strong functional base materials include polyester sheets greater than 200 micrometers in thickness, acrylic sheets, foam board, cardboard, plywood, wood board, gypsum dry wall board, and metal plates.

In another embodiment of the invention, the new image utility comprising a three dimensional shape is preferred. An image with a three dimensional shape provides eye catching appeal that has significant value in advertising. Examples include an image that is formed into a cube, a cylinder or a sphere. The three dimensional shape also could include wrapping an image around a column or a corner for effective trade show display as potential customers are enticed to enter a sales booth.

In another embodiment of the invention, the new image utility comprising an image with a cloth-like surface is preferred. An image with a cloth like surface adds depth of image and texture to the image. The cloth-like surface allows high quality images to have a similar texture to an oil based painting surface and thus would be an ideal surface for fine art reproductions. Further, the cloth-like surface preferably is synergistic to the image content further enhancing the reality of the image content. For example, an advertisement for a wool men's jacket containing a silver halide printed image of a wool jacket can be applied to a functional base that as the same texture as the jacket thus improving the advertising image by allowing the consumer to sense the image visually and by tactile feel.

In a further embodiment of the invention, the new image utility comprising an image on cloth utilized as a window treatment is preferred. By applying a high quality image to cloth like materials typically utilized for window treatment, images can be used to decorate windows. Further, by using a translucent imaging member, the ambient light from the window area can be used to illuminate the image on the window treatment.

In another embodiment of the invention, the new image utility comprising an image on wallpaper base is preferred. By applying the imaging member of the invention to a wallpaper base, high quality images can be applied to interior walls of dwellings. Further, since prior art wallpaper materials are typically printed using gravure printing techniques, customization of prior art wallpaper is difficult and expensive. By applying the imaging member of the invention to wallpaper base, high quality, short run imaging technologies such as silver halide and ink jet printing can be used to create custom wallpaper for consumers. By allowing customization of wallpaper, personal images, that have meaning for individuals, can be utilized to decorate walls of homes.

A polymer sheet that has a spectral transmission of less than 20% is preferred for reflective display uses, as the polymer sheet can provide a reflective opaque image. Spectral transmission greater than 25% has been shown to allow the functional base to interfere with the quality of the image.

In another embodiment of the invention, a polymer sheet with a spectral transmission between 30 and 70% is preferred. In this embodiment, the polymer sheet provides diffusion of the functional base and is critical for imaging members that are to be back illuminated. A spectral transmission less that 25% has been shown to unacceptable reduce the illumination light. A spectral transmission greater than 75% has been shown to allow the illumination light source to reduce the quality of the image as the light sources are not diffused.

In another embodiment of the invention, a polymer sheet with a spectral transmission greater than 90% is preferred. In this embodiment, the image can fully interact with the functional base. A spectral transmission less than 85% has been shown to be low in quality as the image is cloudy. For example, a polymer sheet with spectral transmission greater than 90% containing an image can be adhered to a printed sheet with expanded color gamut, adhered to an opaque white sheet containing a previous image, or adhered to an sheet containing the black and white image to improve the maximum density of the image beyond the current capability of silver halide or thermal dye transfer.

Polymer sheets are preferred because they are tear resistant, have excellent conformability, good chemical resistance and are high in strength. Preferred polymer substrates include polyester, oriented polyolefin such as polyethylene and polypropylene, cast polyolefins such as polypropylene and polyethylene, polystyrene, acetate and vinyl. Polymers are preferred as they are strong and flexible and provide an excellent surface for the coating of silver halide imaging layers.

Biaxially oriented polyolefin sheets are preferred as they are low in cost, have excellent optical properties that optimize the silver halide system, and can be applied to packages in high speed labeling equipment. Microvoided composite biaxially oriented sheets are most preferred because the voided layer provides opacity and lightness without the need for TiO₂. Also, the voided layers of the microvoided biaxially oriented sheets have been shown to significantly reduce pressure sensitivity of the silver halide imaging layers. Microvoided biaxially oriented sheets are conveniently manufactured by coextrusion of the core and surface layers, followed by biaxial orientation, whereby voids are formed around void-initiating material contained in the core layer. Such composite sheets are disclosed in U.S. Pat. Nos. 4,377,616; 4,758,462; 4,632,869; and 5,866,282.

The flexible polymer face stock substrate may contain more than one layer. The skin layers of the flexible substrate can be made of the same polymeric materials as listed above for the core matrix. The composite sheet can be made with skin(s) of the same polymeric material as the core matrix, or it can be made with skin(s) of different polymeric composition than the core matrix. For compatibility, an auxiliary layer can be used to promote adhesion of the skin layer to the core.

Voided biaxially oriented polyolefin sheets are a preferred flexible face stock substrate for the coating of light sensitive silver halide imaging layers. Voided films are preferred as they provide opacity, whiteness and image sharpness to the image. “Void” is used herein to mean devoid of added solid and liquid matter, although it is likely the “voids” contain gas. The void-initiating particles which remain in the finished packaging sheet core should be from 0.1 to 10 μm in diameter and preferably round in shape to produce voids of the desired shape and size. The size of the void is also dependent on the degree of orientation in the machine and transverse directions. Ideally, the void would assume a shape which is defined by two opposed and edge contacting concave disks. In other words, the voids tend to have a lens-like or biconvex shape. The voids are oriented so that the two major dimensions are aligned with the machine and transverse directions of the sheet. The Z-direction axis is a minor dimension and is roughly the size of the cross diameter of the voiding particle. The voids generally tend to be closed cells, and thus there is virtually no path open from one side of the voided-core to the other side through which gas or liquid can traverse.

The image element of this invention generally has a glossy surface, that is, a surface that is sufficiently smooth to provide excellent reflection properties. An opalescent surface may be preferred because it provides a unique photographic appearance to a label that is perceptually preferred by consumers. The opalescent surface is achieved when the microvoids in the vertical direction are between 1 and 3 μm. By the vertical direction, it is meant the direction that is perpendicular to the plane of the imaging member. The thickness of the microvoids preferably is between 0.7 and 1.5 μm for best physical performance and opalescent properties. The preferred number of microvoids in the vertical direction is between 8 and 30. Less than 6 microvoids in the vertical direction do not create the desired opalescent surface. Greater than 35 microvoids in the vertical direction do not significantly improve the optical appearance of the opalescent surface.

The void-initiating material for the flexible polymer substrate may be selected from a variety of materials and should be present in an amount of about 5 to 50% by weight based on the weight of the core matrix polymer. Preferably, the void-initiating material comprises a polymeric material. When a polymeric material is used, it may be a polymer that can be melt-mixed with the polymer from which the core matrix is made and be able to form dispersed spherical particles as the suspension is cooled down. Examples of this would include nylon dispersed in polypropylene, polybutylene terephthalate in polypropylene, or polypropylene dispersed in polyethylene terephthalate. If the polymer is preshaped and blended into the matrix polymer, the important characteristic is the size and shape of the particles. Spheres are preferred and they can be hollow or solid. These spheres may be made from cross-linked polymers which are members selected from the group consisting of an alkenyl aromatic compound having the general formula Ar—C(R)═CH₂, wherein Ar represents an aromatic hydrocarbon radical, or an aromatic halohydrocarbon radical of the benzene series and R is hydrogen or the methyl radical; acrylate-type monomers include monomers of the formula CH₂═C(R′)—C(O)(OR) wherein R is selected from the group consisting of hydrogen and an alkyl radical containing from about 1 to 12 carbon atoms and R′ is selected from the group consisting of hydrogen and methyl; copolymers of vinyl chloride and vinylidene chloride, acrylonitrile and vinyl chloride, vinyl bromide, vinyl esters having formula CH₂═CH(O)COR, wherein R is an alkyl radical containing from 2 to 18 carbon atoms; acrylic acid, methacrylic acid, itaconic acid, citraconic acid, maleic acid, fumaric acid, oleic acid, vinylbenzoic acid; the synthetic polyester resins which are prepared by reacting terephthalic acid and dialkyl terephthalics or ester-forming derivatives thereof, with a glycol of the series HO(CH₂)ₙOH wherein n is a whole number within the range of 2-10 and having reactive olefinic linkages within the polymer molecule, the above-described polyesters which include copolymerized therein up to 20 percent by weight of a second acid or ester thereof having reactive olefinic unsaturation and mixtures thereof, and a cross-linking agent selected from the group consisting of divinylbenzene, diethylene glycol dimethacrylate, diallyl fumarate, diallyl phthalate, and mixtures thereof.

Examples of typical monomers for making the cross-linked polymer void initiating particles include styrene, butyl acrylate, acrylamide, acrylonitrile, methyl methacrylate, ethylene glycol dimethacrylate, vinyl pyridine, vinyl acetate, methyl acrylate, vinylbenzyl chloride, vinylidene chloride, acrylic acid, divinylbenzene, acrylamidomethyl-propane sulfonic acid, vinyl toluene, etc. Preferably, the cross-linked polymer is polystyrene or poly(methyl methacrylate). Most preferably, it is polystyrene, and the cross-linking agent is divinylbenzene.

Processes well known in the art yield nonuniformly sized void initiating particles, characterized by broad particle size distributions. The resulting beads can be classified by screening the beads spanning the range of the original distribution of sizes. Other processes such as suspension polymerization, limited coalescence, directly yield very uniformly sized particles.

The void-initiating materials may be coated with agents to facilitate voiding. Suitable agents or lubricants include colloidal silica, colloidal alumina, and metal oxides such as tin oxide and aluminum oxide. The preferred agents are colloidal silica and alumina, most preferably, silica. The cross-linked polymer having a coating of an agent may be prepared by procedures well known in the art. For example, conventional suspension polymerization processes wherein the agent is added to the suspension is preferred. As the agent, colloidal silica is preferred.

The void-initiating particles can also be inorganic spheres, including solid or hollow glass spheres, metal or ceramic beads or inorganic particles such as clay, talc, barium sulfate, or calcium carbonate. The important thing is that the material does not chemically react with the core matrix polymer to cause one or more of the following problems: (a) alteration of the crystallization kinetics of the matrix polymer, making it difficult to orient, (b) destruction of the core matrix polymer, (c) destruction of the void-initiating particles, (d) adhesion of the void-initiating particles to the matrix polymer, or (e) generation of undesirable reaction products, such as toxic or high color moieties. The void-initiating material should not be photographically active or degrade the performance of the photographic element in which the biaxially oriented polyolefin sheet is utilized.

The total thickness of the topmost skin layer of the polymeric substrate may be between 0.20 μm and 1.5 μm, preferably between 0.5 and 1.0 μm. Below 0.5 μm any inherent nonplanarity in the coextruded skin layer may result in unacceptable color variation. At skin thickness greater than 1.0 μm, there is a reduction in the photographic optical properties such as image resolution. At thickness greater than 1.0 μm, there is also a greater material volume to filter for contamination such as clumps or poor color pigment dispersion.

Addenda may be added to the topmost skin layer of the flexible polymer substrate to change the color of the imaging element. For commercial display products, a white substrate with a slight bluish tinge is preferred. The addition of the slight bluish tinge may be accomplished by any process which is known in the art including the machine blending of color concentrate prior to extrusion and the melt extrusion of blue colorants that have been preblended at the desired blend ratio. Colored pigments that can resist extrusion temperatures greater than 320° C. are preferred, as temperatures greater than 320° C. are necessary for coextrusion of the skin layer. Blue colorants used in this invention may be any colorant that does not have an adverse impact on the imaging element. Preferred blue colorants include Phthalocyanine blue pigments, Cromophtal blue pigments, Irgazin blue pigments, and Irgalite organic blue pigments. Optical brightener may also be added to the skin layer to absorb UV energy and emit light largely in the blue region. TiO₂ may also be added to the skin layer. While the addition of TiO₂ in the thin skin layer of this invention does not significantly contribute to the optical performance of the sheet, it can cause numerous manufacturing problems such as extrusion die lines and spots. The skin layer substantially free of TiO₂ is preferred. TiO₂ added to a layer between 0.20 and 1.5 μm does not substantially improve the optical properties of the support, will add cost to the design, and will cause objectionable pigments lines in the extrusion process.

Addenda may be added to the core matrix and/or to one or more skin layers to improve the optical properties of the flexible substrate. Titanium dioxide is preferred and is used in this invention to improve image sharpness or MTF, opacity, and whiteness. The TiO₂ used may be either anatase or rutile type. Further, both anatase and rutile TiO₂ may be blended to improve both whiteness and sharpness. Examples of TiO₂ that are acceptable for a photographic system are DuPont Chemical Co. R101 rutile TiO₂ and DuPont Chemical Co. R104 rutile TiO₂. Other pigments known in the art to improve photographic optical responses may also be used in this invention. Examples of other pigments known in the art to improve whiteness are talc, kaolin, CaCO₃, BaSO₄, ZnO, TiO₂, ZnS, and MgCO₃. The preferred TiO₂ type is anatase, as anatase TiO₂ has been found to optimize image whiteness and sharpness with a voided layer.

Addenda may be added to the flexible polymer substrate of this invention so that when the biaxially oriented sheet is viewed from a surface, the imaging element emits light in the visible spectrum when exposed to ultraviolet radiation. Emission of light in the visible spectrum allows for the support to have a desired background color in the presence of ultraviolet energy. This is particularly useful when images are viewed outside as sunlight contains ultraviolet energy and may be used to optimize image quality for consumer and commercial applications. An optical brightener is a colorless, fluorescent, organic compound that absorbs ultraviolet light and emits it as visible blue light. Examples include, but are not limited to, derivatives of 4,4′-diaminostilbene-2,2′-disulfonic acid, coumarin derivatives such as 4-methyl-7-diethylaminocoumarin, 1-4-Bis (O-Cyanostyryl) Benzol and 2-Amino-4-Methyl Phenol.

The voids provide added opacity to the flexible polymer substrate. This voided layer can also be used in conjunction with a layer that contains at least one pigment from the group consisting of TiO₂, CaCO₃, clay, BaSO₄, ZnS, MgCO₃, talc, kaolin, or other materials that provide a highly reflective white layer in said film of more than one layer. The combination of a pigmented layer with a voided layer provides advantages in the optical performance of the final image.

Voided layers of the flexible polymer substrate are more susceptible than solid layers to mechanical failure, such as cracking or delamination from adjacent layers. Voided structures that contain TiO₂, or are in proximity to layers containing TiO₂, are particularly susceptible to loss of mechanical properties and mechanical failure with long-term exposure to light. TiO₂ particles initiate and accelerate the photooxidative degradation of polypropylene. The addition of a hindered amine stabilizer to at least one layer of a multilayer biaxially oriented film and in the preferred embodiment in the layers containing TiO₂ and, furthermore, in the most preferred embodiment the hindered amine is in the layer with TiO₂, as well as in the adjacent layers, that improvements to both light and dark keeping image stability are achieved.

The polymer sheet face stock to which the imaging layers are applied preferably contains a stabilizing amount of hindered amine at or about 0.01 to 5% by weight in at least one layer of said film. While these levels provide improved stability to the biaxially oriented film, the preferred amount at or about 0.1 to 3% by weight provides an excellent balance between improved stability for both light and dark keeping, while making the structure more cost effective.

The flexible opaque and translucent polymer sheet carrying the image of this invention which has a microvoided core is preferred. The microvoided core adds opacity and whiteness to the imaging support, further improving imaging quality. Combining the image quality advantages of a microvoided core with a material, which absorbs ultraviolet energy and emits light in the visible spectrum, allows for the unique optimization of image quality, as the image support can have a tint when exposed to ultraviolet energy yet retain excellent whiteness when the image is viewed using lighting that does not contain significant amounts of ultraviolet energy such as indoor lighting.

The coextrusion, quenching, orienting, and heat setting of the flexible face stock substrate to which the image is applied may be effected by any process which is known in the art for producing oriented sheet, such as by a flat sheet process or a bubble or tubular process. The flat sheet process involves extruding the blend through a slit die and rapidly quenching the extruded web upon a chilled casting drum so that the core matrix polymer component of the sheet and the skin components(s) are quenched below their glass solidification temperature. The quenched sheet is then biaxially oriented by stretching in mutually perpendicular directions at a temperature above the glass transition temperature and below the melting temperature of the matrix polymers. The sheet may be stretched in one direction and then in a second direction or may be simultaneously stretched in both directions. After the sheet has been stretched, it is heat set by heating to a temperature sufficient to crystallize or anneal the polymers, while restraining to some degree the sheet against retraction in both directions of stretching.

By having at least one nonvoided skin on the microvoided core, the tensile strength of the flexible face stock substrate is increased and makes the sheet more manufacturable. The higher tensile strength also allows the sheets to be made at wider widths and higher draw ratios than when sheets are made with all layers voided. Coextruding the layers further simplifies the manufacturing process.

In another embodiment of the invention, the thin polymer sheet to which the imaging layers are applied is preferably polyester. The polyester utilized in the invention should have a glass transition temperature between about 50° C. and about 150° C., preferably about 60-100° C., should be orientable, and have an intrinsic viscosity of at least 0.50, preferably 0.6 to 0.9. Suitable polyesters include those produced from aromatic, aliphatic, or cyclo-aliphatic dicarboxylic acids of 4-20 carbon atoms and aliphatic or alicyclic glycols having from 2-24 carbon atoms. Examples of suitable dicarboxylic acids include terephthalic, isophthalic, phthalic, naphthalene dicarboxylic acid, succinic, glutaric, adipic, azelaic, sebacic, fumaric, maleic, itaconic, 1,4-cyclohexane-dicarboxylic, sodiosulfoiso-phthalic, and mixtures thereof. Examples of suitable glycols include ethylene glycol, propylene glycol, butanediol, pentanediol, hexanediol, 1,4-cyclohexane-dimethanol, diethylene glycol, other polyethylene glycols and mixtures thereof. Such polyesters are well known in the art and may be produced by well-known techniques, e.g., those described in U.S. Pat. Nos. 2,465,319 and 2,901,466. Preferred continuous matrix polymers are those having repeat units from terephthalic acid or naphthalene dicarboxylic acid and at least one glycol selected from ethylene glycol, 1,4-butanediol, and 1,4-cyclohexanedimethanol. Poly(ethylene terephthalate), which may be modified by small amounts of other monomers, is especially preferred. Polypropylene is also useful. Other suitable polyesters include liquid crystal copolyesters formed by the inclusion of a suitable amount of a co-acid component such as stilbene dicarboxylic acid. Examples of such liquid crystal copolyesters are those disclosed in U.S. Pat. Nos. 4,420,607; 4,459,402; and 4,468,510.

Suitable cross-linked polymers for the microbeads used in void formation during sheet formation are polymerizable organic materials which are members selected from the group consisting of an alkenyl aromatic compound having the general formula

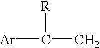

wherein Ar represents an aromatic hydrocarbon radical, or an aromatic halohydrocarbon radical of the benzene series and R is hydrogen or the methyl radical; acrylate-type monomers including monomers of the formula

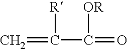

wherein R is selected from the group consisting of hydrogen and an alykl radical containing from about 1 to 12 carbon atoms and R′ is selected from the group consisting of hydrogen and methyl; copolymers of vinyl chloride and vinylidene chloride, acrylonitrile and vinyl chloride, vinyl bromide, vinyl esters having the formula

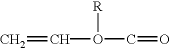

wherein R is an alkyl radical containing from 2 to 18 carbon atoms; acrylic acid, methacrylic acid, itaconic acid, citraconic acid, maleic acid, fumaric acid, oleic acid, vinylbenzoic acid; the synthetic polyester resins which are prepared by reacting terephthalic acid and dialkyl terephthalics or ester-forming derivatives thereof, with a glycol of the series HO(CH₂)ₙOH, wherein n is a whole number within the range of 2-10 and having reactive olefinic linkages within the polymer molecule, the hereinabove described polyesters which include copolymerized therein up to 20 percent by weight of a second acid or ester thereof having reactive olefinic unsaturation and mixtures thereof, and a cross-linking agent selected from the group consisting of divinyl-benzene, diethylene glycol dimethacrylate, oiallyl fumarate, diallyl phthalate, and mixtures thereof.

Functional base materials are utilized in this invention to provide a new feature to the image member. By providing an opaque, translucent and clear polymer sheet with image adhered to, the thin imaging member can interact with the functional base to create a new utility. A preferred functional base material comprises an electroluminescent base.

In another embodiment of the invention, the functional base comprises flooring. By adhering the imaging member to vinyl, ceramic, wood, marble or polyester, the imaging member can be used with flooring materials. Examples include images of simulated marble, advertising images in the floor materials and photographic quality images on ceramic tile.

In a further embodiment of the invention, the functional base comprises a microembossed polymer sheet. The imaging member of the invention adhered to a microembossed polymer sheet provides a unique secondary exposure for silver halide imaging layers and provides a background “sparkle” to the image. In the art, micro-embossing of polymer films is accomplished by heating of the polymer web to the Tg of the polymer and embossing microprismatic elements into the polymer followed by subsequent cooling of the sheet. A typical embossing depth is 0.085 mm and can be accomplished by heated embossed roll or using a ultra-sonic horn vibrated at 20 Khz.

In another embodiment of the invention, the functional base comprises a hologram. By adhering the imaging member of the invention to a hologram depth of image in provided by the functional base allowing the image of the invention to interact with the hologram below the image member.

In a further embodiment of the invention, the functional base and the imaging member comprise a transparent polymer. By providing the image member and the functional base on a transparent member, a clear image element can be used for projection. Examples include clear display, overhead projection, window decals or optical encoders.

In another embodiment of the invention, the functional base comprises a metal. By adhering the imaging member of the invention to a metal, the imaging member acquires the look and feel of metal. Further, the metal provides protection to the image member by providing stiffness and a oxygen barrier. Suitable metals include steel, aluminum, nickel, gold, silver, and metallic alloys.

In a further embodiment of the invention, the functional base is magnetic. By providing a magnetic surface, the imaging member can be applied to metallic surfaces such as refrigerators. Further, magnets are used to secure display materials to surfaces for trade shows, points of purchase and in museums.

In another embodiment of the invention, the functional base comprises a hook and loop fastening system. By adhering the imaging member to a functional base that contains a hook and loop system, images can be adhered to surfaces that have loose fibers such as cloth materials. The hook and loop system also allows for easy removal and set up of display booths at trade shows.

In a further embodiment of the invention, the functional member comprises a sail for wind powered water crafts. By adhering an image to a material suitable for a sail, the sail can be decorated with images, numbers, flags and advertisement. Further, the thin polymer sheets of the invention tend to be flexible and resistant to air flow making the thin polymer sheets ideal for a sail material.

In another embodiment of the invention, the functional base comprises a colored surface and the imaging member comprises a thin transparent polymer sheet. By providing a colored functional base, the background color of the functional base can interact with the image member providing for example expanded color gamut to silver halide images or a high density background color for inkjet printing of pigmented ink images.

In a further embodiment of the invention, the functional base comprises an optical diffuser. The image member adhered to a optical diffuser provides a transmission display material suitable for back illumination display. By adhering a silver halide image onto a diffuser screen, problems with yellowing associated with TiO₂ are avoided. Preferred diffuser screens comprise voided polyolefin and voided polyester. Examples of preferred polymer diffuser screens are contained in U.S. Pat. Nos. 6,093,521 and 6,030,756.

The adhesives utilized to adhere the image member to the functional base are preferably heat activated adhesives or pressure sensitive adhesives. The adhesives preferably are applied to the backside of the image member on the thin polymer sheet. By providing the adhesive on the image member, the commercial labs have an adhesive system for lamination to the functional bases of the invention. Preferred photographic adhesives of this invention must not interact with the light sensitive silver halide imaging system so that image quality is deteriorated. Further, since photographic elements of this invention must be photo processed, the performance of the photographic label adhesive of this invention must not be deteriorated by photographic processing chemicals. Preferred adhesive may be inorganic or organic, natural or synthetic, that is capable of bonding the image to the desired surface by surface attachment. Examples of inorganic adhesives are soluble silicates, ceramic and thermosetting powdered glass. Organic photographic adhesives may be natural or synthetic. Examples of natural organic photographic label adhesives include bone glue, soybean starch cellulosics, rubber latex, gums, terpene, mucilages and hydrocarbon resins. Examples of synthetic organic photographic label adhesives include elastomer solvents, polysulfide sealants, theromplastic resins such as isobutylene and polyvinyl acetate, theromsetting resins such as epoxy, phenoformaldehyde, polyvinyl butyral and cyanoacrylates and silicone polymers.

For single or multiple layer adhesive systems, the preferred adhesive composition is selected from the group consisting of natural rubber, syntheic rubber, acrylics, acrylic copolymers, vinyl polymers, vinyl acetate-, urethane, acrylate-type materials, copolymer mixtures of vinyl chloride-vinyl acetate, polyvinylidene, vinyl acetate-acrylic acid copolymers, styrene butadiene, carboxylated stryrene butadiene copolymers, ethylene copolymers, polyvinyl alcohol, polyesters and copolymers, cellulosic and modified cellulosic, starch and modified starch compounds, epoxies, polyisocyanate, polyimides.

For single or multiple layer adhesive systems, the preferred label adhesive composition is selected from the group consisting of epoxy, phenoformaldehyde, polyvinyl butyral, cyanoacrylates, rubber based photographic label adhesives, styrene/butadiene based photographic label adhesives, acrylics and vinyl derivatives.

Used herein, the phrase ‘imaging member’ comprises an imaging support as described above along with an image receiving layer as applicable to multiple techniques governing the transfer of an image onto the imaging member. Such techniques include thermal dye transfer, electrophotographic printing, or ink jet printing, as well as a support for photographic silver halide images. As used herein, the phrase “photographic element” is a material that utilizes photosensitive silver halide in the formation of images.

The thermal dye image-receiving layer of the receiving elements of the invention may comprise, for example, a polycarbonate, a polyurethane, a polyester, polyvinyl chloride, poly(styrene-co-acrylonitrile), poly(caprolactone), or mixtures thereof. The dye image-receiving layer may be present in any amount that is effective for the intended purpose. In general, good results have been obtained at a concentration of from about 1 to about 10 g/m². An overcoat layer may be further coated over the dye-receiving layer, such as described in U.S. Pat. No. 4,775,657 of Harrison et al.

Dye-donor elements that are used with the dye-receiving element of the invention conventionally comprise a support having thereon a dye containing layer. Any dye can be used in the dye-donor employed in the invention, provided it is transferable to the dye-receiving layer by the action of heat. Especially good results have been obtained with sublimable dyes. Dye donors applicable for use in the present invention are described, e.g., in U.S. Pat. Nos. 4,916,112; 4,927,803; and 5,023,228. As noted above, dye-donor elements are used to form a dye transfer image. Such a process comprises image-wise-heating a dye-donor element and transferring a dye image to a dye-receiving element as described above to form the dye transfer image. In a preferred embodiment of the thermal dye transfer method of printing, a dye donor element is employed which compromises a poly(ethylene terephthalate) support coated with sequential repeating areas of cyan, magenta, and yellow dye, and the dye transfer steps are sequentially performed for each color to obtain a three-color dye transfer image. When the process is only performed for a single color, then a monochrome dye transfer image is obtained.

Thermal printing heads which can be used to transfer dye from dye-donor elements to receiving elements of the invention are available commercially. There can be employed, for example, a Fujitsu Thermal Head (FTP-040 MCS001), a TDK Thermal Head F415 HH7-1089, or a Rohm Thermal Head KE 2008-F3. Alternatively, other known sources of energy for thermal dye transfer may be used, such as lasers as described in, for example, GB No. 2,083,726A.

A thermal dye transfer assemblage of the invention comprises (a) a dye-donor element, and (b) a dye-receiving element as described above, the dye-receiving element being in a superposed relationship with the dye-donor element so that the dye layer of the donor element is in contact with the dye image-receiving layer of the receiving element.

When a three-color image is to be obtained, the above assemblage is formed on three occasions during the time when heat is applied by the thermal printing head. After the first dye is transferred, the elements are peeled apart. A second dye-donor element (or another area of the donor element with a different dye area) is then brought in register with the dye-receiving element and the process repeated. The third color is obtained in the same manner.

The electrographic and electrophotographic processes and their individual steps have been well described in the prior art. The processes incorporate the basic steps of creating an electrostatic image, developing that image with charged, colored particles (toner), optionally transferring the resulting developed image to a secondary substrate, and fixing the image to the substrate. There are numerous variations in these processes and basic steps; the use of liquid toners in place of dry toners is simply one of those variations.

The first basic step, creation of an electrostatic image, can be accomplished by a variety of methods. The electrophotographic process of copiers uses imagewise photodischarge, through analog or digital exposure, of a uniformly charged photoconductor. The photoconductor may be a single-use system, or it may be rechargeable and reimageable, like those based on selenium or organic photoreceptors.

In one form, the electrophotographic process of copiers uses imagewise photodischarge, through analog or digital exposure, of a uniformly charged photoconductor. The photoconductor may be a single-use system, or it may be rechargeable and reimageable, like those based on selenium or organic photoreceptors.

In an alternate electrographic process, electrostatic images are created ionographically. The latent image is created on dielectric (charge-holding) medium, either paper or film. Voltage is applied to selected metal styli or writing nibs from an array of styli spaced across the width of the medium, causing a dielectric breakdown of the air between the selected styli and the medium. Ions are created, which form the latent image on the medium.

Electrostatic images, however generated, are developed with oppositely charged toner particles. For development with liquid toners, the liquid developer is brought into direct contact with the electrostatic image. Usually a flowing liquid is employed to ensure that sufficient toner particles are available for development. The field created by the electrostatic image causes the charged particles, suspended in a nonconductive liquid, to move by electrophoresis. The charge of the latent electrostatic image is thus neutralized by the oppositely charged particles. The theory and physics of electrophoretic development with liquid toners are well described in many books and publications.

If a re-imageable photoreceptor or an electrographic master is used, the toned image is transferred to paper (or other substrate). The paper is charged electrostatically, with the polarity chosen to cause the toner particles to transfer to the paper. Finally, the toned image is fixed to the paper. For self-fixing toners, residual liquid is removed from the paper by air-drying or heating. Upon evaporation of the solvent, these toners form a film bonded to the paper. For heat-fusible toners, thermoplastic polymers are used as part of the particle. Heating both removes residual liquid and fixes the toner to paper.

When used as ink jet imaging media, the recording elements or media typically comprise a substrate or a support material having on at least one surface thereof an ink-receiving or image-forming layer. If desired, in order to improve the adhesion of the ink receiving layer to the support, the surface of the support may be corona-discharge-treated prior to applying the solvent-absorbing layer to the support or, alternatively, an undercoating, such as a layer formed from a halogenated phenol or a partially hydrolyzed vinyl chloride-vinyl acetate copolymer, can be applied to the surface of the support. The ink receiving layer is preferably coated onto the support layer from water or water-alcohol solutions at a dry thickness ranging from 3 to 75 micrometers, preferably 8 to 50 micrometers.

Any known ink jet receiver layer can be used in combination with the external polyester-based barrier layer of the present invention. For example, the ink receiving layer may consist primarily of inorganic oxide particles such as silicas, modified silicas, clays, aluminas, fusible beads such as beads comprised of thermoplastic or thermosetting polymers, non-fusible organic beads, or hydrophilic polymers such as naturally-occurring hydrophilic colloids and gums such as gelatin, albumin, guar, xantham, acacia, chitosan, starches and their derivatives, and the like; derivatives of natural polymers such as functionalized proteins, functionalized gums and starches, and cellulose ethers and their derivatives; and synthetic polymers such as polyvinyloxazoline, polyvinylmethyloxazoline, polyoxides, polyethers, poly(ethylene imine), poly(acrylic acid), poly(methacrylic acid), n-vinyl amides including polyacrylamide and polyvinylpyrrolidone, and poly(vinyl alcohol), its derivatives and copolymers; and combinations of these materials. Hydrophilic polymers, inorganic oxide particles, and organic beads may be present in one or more layers on the substrate and in various combinations within a layer.

A porous structure may be introduced into ink receiving layers comprised of hydrophilic polymers by the addition of ceramic or hard polymeric particulates, by foaming or blowing during coating, or by inducing phase separation in the layer through introduction of non-solvent. In general, it is preferred for the base layer to be hydrophilic, but not porous. This is especially true for photographic quality prints, in which porosity may cause a loss in gloss. In particular, the ink receiving layer may consist of any hydrophilic polymer or combination of polymers with or without additives as is well known in the art.

If desired, the ink receiving layer can be overcoated with an ink-permeable, anti-tack protective layer such as, for example, a layer comprising a cellulose derivative or a cationically-modified cellulose derivative or mixtures thereof. An especially preferred overcoat is poly β-1,4-anhydro-glucose-g-oxyethylene-g-(2′-hydroxypropyl)-N,N-dimethyl-N-dodecylammonium chloride. The overcoat layer is non porous, but is ink permeable and serves to improve the optical density of the images printed on the element with water-based inks. The overcoat layer can also protect the ink receiving layer from abrasion, smudging, and water damage. In general, this overcoat layer may be present at a dry thickness of about 0.1 to about 5 μm, preferably about 0.25 to about 3 μm.

In practice, various additives may be employed in the ink receiving layer and overcoat. These additives include surface active agents such as surfactant(s) to improve coatability and to adjust the surface tension of the dried coating, acid or base to control the pH, antistatic agents, suspending agents, antioxidants, hardening agents to cross-link the coating, antioxidants, UV stabilizers, light stabilizers, and the like. In addition, a mordant may be added in small quantities (2%-10% by weight of the base layer) to improve waterfastness. Useful mordants are disclosed in U.S. Pat. No. 5,474,843.

The layers described above, including the ink receiving layer and the overcoat layer, may be coated by conventional coating means onto a transparent or opaque support material commonly used in this art. Coating methods may include, but are not limited to, blade coating, wound wire rod coating, slot coating, slide hopper coating, gravure, curtain coating, and the like. Some of these methods allow for simultaneous coatings of both layers, which is preferred from a manufacturing economic perspective.

The DRL (dye receiving layer) is coated over the tie layer or TL at a thickness ranging from 0.1-10 μm, preferably 0.5-5 μm. There are many known formulations which may be useful as dye receiving layers. The primary requirement is that the DRL is compatible with the inks which it will be imaged so as to yield the desirable color gamut and density. As the ink drops pass through the DRL, the dyes are retained or mordanted in the DRL, while the ink solvents pass freely through the DRL and are rapidly absorbed by the TL. Additionally, the DRL formulation is preferably coated from water, exhibits adequate adhesion to the TL, and allows for easy control of the surface gloss.

For example, Misuda et al in U.S. Pat. Nos. 4,879,166; 5,264,275; 5,104,730; 4,879,166, and Japanese Patents 1,095,091; 2,276,671; 2,276,670; 4,267,180; 5,024,335; and 5,016,517 disclose aqueous based DRL formulations comprising mixtures of psuedo-bohemite and certain water soluble resins. Light in U.S. Pat. Nos. 4,903,040; 4,930,041; 5,084,338; 5,126,194; 5,126,195; and 5,147,717 discloses aqueous-based DRL formulations comprising mixtures of vinyl pyrrolidone polymers and certain water-dispersible and/or water-soluble polyesters, along with other polymers and addenda. Butters et al in U.S. Pat. Nos. 4,857,386 and 5,102,717 disclose ink-absorbent resin layers comprising mixtures of vinyl pyrrolidone polymers and acrylic or methacrylic polymers. Sato et al in U.S. Pat. No. 5,194,317 and Higuma et al in U.S. Pat. No. 5,059,983 disclose aqueous-coatable DRL formulations based on poly(vinyl alcohol). Iqbal in U.S. Pat. No. 5,208,092 discloses water-based IRL formulations comprising vinyl copolymers which are subsequently cross-linked. In addition to these examples, there may be other known or contemplated DRL formulations which are consistent with the aforementioned primary and secondary requirements of the DRL, all of which fall under the spirit and scope of the current invention.

The preferred DRL is 0.1-10 micrometers thick and is coated as an aqueous dispersion of 5 parts alumoxane and 5 parts poly(vinyl pyrrolidone). The DRL may also contain varying levels and sizes of matting agents for the purpose of controlling gloss, friction, and/or fingerprint resistance, surfactants to enhance surface uniformity and to adjust the surface tension of the dried coating, mordanting agents, antioxidants, UV absorbing compounds, light stabilizers, and the like.

Although the ink-receiving elements as described above can be successfully used to achieve the objectives of the present invention, it may be desirable to overcoat the DRL for the purpose of enhancing the durability of the imaged element. Such overcoats may be applied to the DRL either before or after the element is imaged. For example, the DRL can be overcoated with an ink-permeable layer through which inks freely pass. Layers of this type are described in U.S. Pat. Nos. 4,686,118; 5,027,131; and 5,102,717. Alternatively, an overcoat may be added after the element is imaged. Any of the known laminating films and equipment may be used for this purpose. The inks used in the aforementioned imaging process are well known, and the ink formulations are often closely tied to the specific processes, i.e., continuous, piezoelectric, or thermal. Therefore, depending on the specific ink process, the inks may contain widely differing amounts and combinations of solvents, colorants, preservatives, surfactants, humectants, and the like. Inks preferred for use in combination with the image recording elements of the present invention are water-based, such as those currently sold for use in the Hewlett-Packard Desk Writer 560C printer. However, it is intended that alternative embodiments of the image-recording elements as described above, which may be formulated for use with inks which are specific to a given ink-recording process or to a given commercial vendor, fall within the scope of the present invention.

Smooth opaque paper bases are useful in combination with silver halide images because the contrast range of the silver halide image is improved, and show through of ambient light during image viewing is reduced. The preferred photographic element of this invention is directed to a silver halide photographic element capable of excellent performance when exposed by either an electronic printing method or a conventional optical printing method. An electronic printing method comprises subjecting a radiation sensitive silver halide emulsion layer of a recording element to actinic radiation of at least 10⁻⁴ ergs/cm² for up to 100μ seconds duration in a pixel-by-pixel mode wherein the silver halide emulsion layer is comprised of silver halide grains as described above. A conventional optical printing method comprises subjecting a radiation sensitive silver halide emulsion layer of a recording element to actinic radiation of at least 10⁻⁴ ergs/cm² for 10⁻³ to 300 seconds in an imagewise mode wherein the silver halide emulsion layer is comprised of silver halide grains as described above. This invention in a preferred embodiment utilizes a radiation-sensitive emulsion comprised of silver halide grains (a) containing greater than 50 mole percent chloride based on silver, (b) having greater than 50 percent of their surface area provided by {100} crystal faces, and (c) having a central portion accounting for from 95 to 99 percent of total silver and containing two dopants selected to satisfy each of the following class requirements: (i) a hexacoordination metal complex which satisfies the formula:

[ML_{6]}ⁿ (I)

wherein n is zero, −1, −2, −3, or −4; M is a filled frontier orbital polyvalent metal ion, other than iridium; and L₆ represents bridging ligands which can be independently selected, provided that at least four of the ligands are anionic ligands, and at least one of the ligands is a cyano ligand or a ligand more electronegative than a cyano ligand; and (ii) an iridium coordination complex containing a thiazole or substituted thiazole ligand. Preferred photographic imaging layer structures are described in EP Publication 1 048 977, U.S. Pat. Nos. 5,866,282 and 6,071,680. The photosensitive imaging layers described therein provide particularly desirable images on the base of this invention.

Since the image members of the invention tend to be delicate and generally not resistant to water and other environmental solvents, the imaging member preferably contains an environmental protection layer. The environmental protection layer may consist of suitable material that protects the image from environmental solvents, resists scratching, and does not interfere with the image quality. The environmental protection layer is preferably applied to a photographic image after image development because the liquid processing chemistry required for image development must be able to efficiently penetrate the surface of the imaging layers to contact the silver halide and couplers utilizing typical silver halide imaging processes or to a ink jet image after printing.

An environmental protection layer where transparent polymer particles are applied to the topmost surface of the imaging layers in the presence of an electric field and fused to the topmost layer causing the transparent polymer particles to form a continuous polymeric layer is suitable. An electrophotographic toner applied polymer is preferred, as it is an effective way to provide a thin, protective environmental layer to the photographic label that has been shown to withstand environmental solvents and damage due to handling.

In another embodiment, the environmental protection layer is coatable from aqueous solution, which survives exposure and processing, and forms a continuous, water-impermeable protective layer in a post-process fusing step. The environmental protection layer is preferably formed by coating polymer beads or particles of 0.1 to 50 μm in average size together with a polymer latex binder on the emulsion side of a sensitized photographic product. Optionally, a small amount of water-soluble coating aids (viscosifiers, surfactants) can be included in the layer, as long as they leach out of the coating during processing. After exposure and processing, the product with image is treated in such a way as to cause fusing and coalescence of the coated polymer beads, by heat and/or pressure (fusing), solvent treatment, or other means so as to form the desired continuous, water impermeable protective layer.

Examples of suitable polymers from which the polymer particles used in environmental protection layer can be selected include poly(vinyl chloride), poly(vinylidene chloride), poly(vinyl chloride-co-vinylidene chloride), chlorinated polypropylene, poly(vinyl chloride-co-vinyl acetate), poly(vinyl chloride-co-vinyl acetate-co-maleic anhydride), ethyl cellulose, nitrocellulose, poly(acrylic acid) esters, linseed oil-modified alkyd resins, rosin-modified alkyd resins, phenol-modified alkyd resins, phenolic resins, polyesters, poly(vinyl butyral), polyisocyanate resins, polyurethanes, poly(vinyl acetate), polyamides, chroman resins, dammar gum, ketone resins, maleic acid resins, vinyl polymers, such as polystyrene and polyvinyltoluene or copolymer of vinyl polymers with methacrylates or acrylates, poly(tetrafluoroethylene-hexafluoropropylene), low-molecular weight polyethylene, phenol-modified pentaerythritol esters, poly(styrene-co-indene-co-acrylonitrile), poly(styrene-co-indene), poly(styrene-co-acrylonitrile), poly(styrene-co-butadiene), poly(stearyl methacrylate) blended with poly(methyl methacrylate), copolymers with siloxanes and polyalkenes. These polymers can be used either alone or in combination. In a preferred embodiment of the invention, the polymer comprises a polyester or poly(styrene-co-butyl acrylate). Preferred polyesters are based on ethoxylated and/or propoxylated bisphenol A and one or more of terephthalic acid, dodecenylsuccinic acid and fumaric acid as they form an acceptable environmental protection layer that generally survives the rigors of a packaging label.

To increase the abrasion resistance of the environmental protection layer, polymers which are cross-linked or branched can be used. For example, poly(styrene-co-indene-co-divinylbenzene), poly(styrene-co-acrylonitrile-co-divinylbenzene), or poly(styrene-co-butadiene-co-divinylbenzene) can be used.

The polymer particles for the environmental protection layer should be transparent, and are preferably colorless. But it is specifically contemplated that the polymer particle can have some color for the purposes of color correction, or for special effects, so long as the image is viewable through the overcoat. Thus, there can be incorporated into the polymer particle dye which will impart color. In addition, additives can be incorporated into the polymer particle which will give to the overcoat desired properties. For example, a UV absorber can be incorporated into the polymer particle to make the overcoat UV absorptive, thus protecting the image from UV induced fading or blue tint can be incorporated into the polymer particle to offset the native yellowness of the gelatin used in the silver halide imaging layers.

In addition to the polymer particles which form the environmental protection layer, there can be combined with the polymer composition other particles which will modify the surface characteristics of the element. Such particle are solid and nonfusible at the conditions under which the polymer particles are fused, and include inorganic particles, like silica, and organic particles, like methylmethacrylate beads, which will not melt during the fusing step and which will impart surface roughness to the overcoat.

The surface characteristics of the environmental protection layer are in large part dependent upon the physical characteristics of the polymer which forms the toner and the presence or absence of solid, nonfusible particles. However, the surface characteristics of the overcoat also can be modified by the conditions under which the surface is fused. For example, the surface characteristics of the fusing member that is used to fuse the toner to form the continuous overcoat layer can be selected to impart a desired degree of smoothness, texture or pattern to the surface of the element. Thus, a highly smooth fusing member will give a glossy surface to the imaged element, a textured fusing member will give a matte or otherwise textured surface to the element, a patterned fusing member will apply a pattern to the surface of the element.

Suitable examples of the polymer latex binder include a latex copolymer of butyl acrylate, 2-acrylamido-2-methylpropanesulfonate, and acetoacetoxyethylmethacrylate. Other latex polymers which are useful include polymers having a 20 to 10,000 nm diameter and a Tg of less than 60° C. suspended in water as a colloidal suspension.

Examples of suitable coating aids for the environmental protection layer include any water soluble polymer or other material that imparts appreciable viscosity to the coating suspension, such as high MW polysaccharide derivatives (e.g. xanthan gum, guar gum, gum acacia, Keltrol (an anionic polysaccharide supplied by Merck and Co., Inc.) high MW polyvinyl alcohol, carboxymethylcellulose, hydroxyethylcellulose, polyacrylic acid and its salts, polyacrylamide, etc). Surfactants include any surface active material that will lower the surface tension of the coating preparation sufficiently to prevent edge-withdrawal, repellencies, and other coating defects. These include alkyloxy- or alkylphenoxypolyether or polyglycidol derivatives and their sulfates, such as nonylphenoxypoly(glycidol) available from Olin Matheson Corporation or sodium octylphenoxypoly(ethyleneoxide) sulfate, organic sulfates or sulfonates, such as sodium dodecyl sulfate, sodium dodecyl sulfonate, sodium bis(2-ethylhexyl)sulfosuccinate (Aerosol OT), and alkylcarboxylate salts such as sodium decanoate.

The application of an ultraviolet polymerizable monomers and oligomers to the outermost layer of the imaging layers and subsequent radiation exposure to form a thin cross-linked protective layer is preferred. UV cure polymers are preferred, as they can easily be applied to the outermost layer of the silver halide imaging layers and have been shown to provide an acceptable protective layer for the silver halide label material. Preferred UV cure polymers include aliphatic urethane, allyl methacrylate, ethylene glycol dimethacrylate, polyisocyanate and hydroxyethyl methacrylate. A preferred photoinitiator is benzil dimethyl ketal. The preferred intensity of radiation is between 0.1 and 1.5 milliwatt/cm². Below 0.05, insufficient cross-linking occurs yielding a protective layer that does not offer sufficient protection for the labeling of packages.

The application of a pre-formed polymer layer to the outermost surface of the image to form an environmental protection layer is also preferred. Application of a pre-formed sheet is preferred because pre-formed sheets are tough and durable easily withstanding the environmental solvents and handling forces applied to the image member. Application of the pre-formed polymer sheet is preferable carried out though lamination after image development or printing. An adhesive is applied to either the image or the pre-formed polymer sheet prior to a pressure nip that adheres the two surfaces and eliminates any trapped air that would degrade the quality of the image.

The pre-formed sheet preferably is an oriented transparent polymer because of the strength and toughness developed in the orientation process. Preferred polymers for the flexible substrate include polyolefins, polyester and nylon. Preferred polyolefins include polypropylene, polyethylene, polymethylpentene, polystyrene, polybutylene, and mixtures thereof. Polyolefin copolymers, including copolymers of propylene and ethylene such as hexene, butene, and octene are also useful. Polypropylene is most preferred, as it is low in cost and has desirable strength and toughness properties required for a pressure sensitive label.

The application of a synthetic latex to the image member is another preferred environmental protection layer. A coating of synthetic latex has been shown to provide an acceptable environmental protection layer and can be coated in an aqueous solution eliminating exposure to solvents. The coating of latex has been shown to provide an acceptable environmental protection layer for the silver halide packaging label. Preferred synthetic latexes for the environmental protection layer are made by emulsion polymerization techniques from styrene butadiene copolymer, acrylate resins, and polyvinyl acetate. The preferred particles size for the synethetic latex ranges from 0.05 to 0.15 μm. The synthetic latex is applied to the outermost layer of the silver halide imaging layers by known coating methods that include rod coating, roll coating and hopper coating. The synthetic latexes must be dried after application and must dry transparent so as not to interfere with the quality of the image.

### EXAMPLES

### Example 1

In this example a silver halide pressure sensitive imaging member was created by applying a light sensitive silver halide imaging layers to an opaque polymer sheet. The opaque polymer sheet consisted of a flexible white biaxially oriented polypropylene face stock backside coated with a pressure sensitive adhesive that was adhesive laminated to a paper carrier sheet. The light sensitive silver halide imaging layers were a yellow, magenta, and cyan coupler system capable of accurate reproduction of flesh tone. After processing the imaging member, the photographic label was coated with an environmental protection layer to protect the delicate silver halide imaging layers from environmental solvents. The image member was then pressure sensitive laminated to a variety of functional bases to demonstrate a new image utility.

Biaxially Oriented Polyolefin Polymer Sheet:

A composite sheet polyolefin sheet (150 μm thick) (d=0.68 g/cc) consisting of a microvoided and oriented polypropylene core (approximately 60% of the total sheet thickness), with a homopolymer non-microvoided oriented polypropylene layer on each side of the voided layer; the void initiating material used was poly(butylene terephthalate). The polyolefin sheet had a skin layer consisting of polyethylene and a blue pigment. The polypropylene layer adjacent the voided layer contained 24% rutile TiO₂. The silver halide imaging layers were applied to the blue tinted polyethylene skin layer.

Pressure Sensitive Adhesive:

Permanent solvent based acrylic adhesive 12 μm thick

Paper Carrier Sheet:

A laminated paper carrier sheet that consisted of a cellulose paper core (80 micrometers thick) on to which a biaxially oriented sheet of polypropylene was extrusion laminated to the backside utilizing LDPE resin. The backside oriented polypropylene contained a roughness layer to allow for efficient transport in photographic printing equipment. The roughness layer consisted of a mixture of polyethylene and polypropylene immiscible polymers. The topside of the liner was extrusion coated with LDPE. The cellulose paper contained 8% moisture and 1% salt for conductivity. The total thickness of the laminated paper liner was 128 micrometers, and the stiffness was 80 millinewtons in both the machine and cross directions. The paper liner was coated with a silicone release coat adjacent to the extruded LDPE layer.

Silver chloride emulsions were chemically and spectrally sensitized as described below. A biocide comprising a mixture of N-methyl-isothiazolone and N-methyl-5-chloro-isthiazolone was added after sensitization.

Blue Sensitive Emulsion (Blue EM-1). A high chloride silver halide emulsion is precipitated by adding approximately equimolar silver nitrate and sodium chloride solutions into a well-stirred reactor containing glutaryldiaminophenyldisulfide, gelatin peptizer, and thioether ripener. Cesium pentachloronitrosylosmate(II) dopant is added during the silver halide grain formation for most of the precipitation, followed by the addition of potassium hexacyanoruthenate(II), potassium (5-methyl-thiazole)-pentachloroiridate, a small amount of KI solution, and shelling without any dopant. The resultant emulsion contains cubic-shaped grains having edge length of 0.6 μm. The emulsion is optimally sensitized by the addition of a colloidal suspension of aurous sulfide and heat ramped to 60° C., during which time blue sensitizing dye BSD-4, potassium hexchloroiridate, Lippmann bromide, and 1-(3-acetamidophenyl)-5-mercaptotetrazole were added.

Green Sensitive Emulsion (Green EM-1): A high chloride silver halide emulsion is precipitated by adding approximately equimolar silver nitrate and sodium chloride solutions into a well-stirred reactor containing gelatin peptizer and thioether ripener. Cesium pentachloronitrosylosmate(II) dopant is added during the silver halide grain formation for most of the precipitation, followed by the addition of potassium (5-methylthiazole)-pentachloroiridate. The resultant emulsion contains cubic-shaped grains of 0.3 μm in edge length size. The emulsion is optimally sensitized by the addition of glutaryldiaminophenyldisulfide, a colloidal suspension of aurous sulfide and heat ramped to 55° C., during which time potassium hexachloroiridate doped Lippmann bromide, a liquid crystalline suspension of green sensitizing dye GSD-1, and 1-(3-acetamidophenyl)-5-mercaptotetrazole were added.

Red Sensitive Emulsion (Red EM-1): A high chloride silver halide emulsion is precipitated by adding approximately equimolar silver nitrate and sodium chloride solutions into a well-stirred reactor containing gelatin peptizer and thioether ripener. During the silver halide grain formation, potassium hexacyanoruthenate(II) and potassium (5-methylthiazole)-pentachloroiridate are added. The resultant emulsion contains cubic shaped grains of 0.4 μm in edge length size. The emulsion is optimally sensitized by the addition of glutaryldiaminophenyldisulfide, sodium thiosulfate, tripotassium bis{2-[3-(2-sulfobenzamido)phenyl]-mercaptotetrazole} gold(I) and heat ramped to 64° C., during which time 1-(3-acetamidophenyl)-5-mercaptotetrazole, potassium hexachloroiridate, and potassium bromide are added. The emulsion is then cooled to 40° C., pH adjusted to 6.0, and red sensitizing dye RSD-1 is added.

Coupler dispersions were emulsified by methods well known to the art, and the following layers were coated on the following support:

The following flesh tone optimized light sensitive silver halide imaging layers were utilized to prepare photographic label utilizing the invention label base material. The following imaging layers were coated utilizing curtain coating:

| Layer | Item | Laydown (g/m²) |
|---|---|---|
| Layer 1 | Blue Sensitive Layer | |
| | Gelatin | 1.3127 |
| | Blue sensitive silver (Blue EM-1) | 0.2399 |
| | Y-4 | 0.4143 |
| | ST-23 | 0.4842 |
| | Tributyl Citrate | 0.2179 |
| | ST-24 | 0.1211 |
| | ST-16 | 0.0095 |
| | Sodium Phenylmercaptotetrazole | 0.0001 |
| | Piperidino hexose reductone | 0.0024 |
| | 5-chloro-2-methyl-4-isothiazolin-3-one/2- | 0.0002 |
| | methyl-4-isothiazolin-3-one(3/1) | |
| | SF-1 | 0.0366 |
| | Potassium chloride | 0.0204 |
| | Dye-1 | 0.0148 |
| Layer 2 | Interlayer | |
| | Gelatin | 0.7532 |
| | ST-4 | 0.1076 |
| | S-3 | 0.1969 |
| | 5-chloro-2-methyl-4-isothiazolin-3-one/2- | 0.0001 |
| | methyl-4-isothiazolin-3-one(3/1) | |
| | Catechol disulfonate | 0.0323 |
| | SF-1 | 0.0081 |
| Layer 3 | Green Sensitive Layer | |
| | Gelatin | 1.1944 |
| | Green Sensitive Silver (Green EM-1) | 0.1011 |
| | M-4 | 0.2077 |
| | Oleyl Alcohol | 0.2174 |
| | S-3 | 0.1119 |
| | ST-21 | 0.0398 |
| | ST-22 | 0.2841 |
| | Dye-2 | 0.0073 |
| | 5-chloro-2-methyl-4-isothiazolin-3-one/2- | 0.0001 |
| | methyl-4-isothiazolin-3-one(3/1) | |
| | SF-1 | 0.0236 |
| | Potassium chloride | 0.0204 |
| | Sodium Phenylmercaptotetrazole | 0.0007 |
| Layer 4 | M/C Interlayer | |
| | Gelatin | 0.7532 |
| | ST-4 | 0.1076 |
| | S-3 | 0.1969 |
| | Acrylamide/t-Butylacrylamide sulfonate | 0.0541 |
| | copolymer | |
| | Bis-vinylsulfonylmethane | 0.1390 |
| | 3,5-Dinitrobenzoic acid | 0.0001 |
| | Citric acid | 0.0007 |
| | Catechol disulfonate | 0.0323 |
| | 5-chloro-2-methyl-4-isothiazolin-3-one/2- | 0.0001 |
| | methyl-4-isothiazolin-3-one(3/1) | |
| Layer 5 | Red Sensitive Layer | |
| | Gelatin | 1.3558 |
| | Red Sensitive silver (Red EM-1) | 0.1883 |
| | IC-35 | 0.2324 |
| | IC-36 | 0.0258 |
| | UV-2 | 0.3551 |
| | Dibutyl sebacate | 0.4358 |
| | S-6 | 0.1453 |
| | Dye-3 | 0.0229 |
| | Potassium p-toluenethiosulfonate | 0.0026 |
| | 5-chloro-2-methyl-4-isothiazolin-3-one/2- | 0.0001 |
| | methyl-4-isothiazolin-3-one(3/1) | |
| | Sodium Phenylmercaptotetrazole | 0.0005 |
| | SF-1 | 0.0524 |
| Layer 6 | UV Overcoat | |
| | Gelatin | 0.8231 |
| | UV-1 | 0.0355 |
| | UV-2 | 0.2034 |
| | ST-4 | 0.0655 |
| | SF-1 | 0.0125 |
| | S-6 | 0.0797 |
| | 5-chloro-2-methyl-4-isothiazolin-3-one/2- | 0.0001 |
| | methyl-4-isothiazolin-3-one(3/1) | |
| Layer 7 | SOC | |
| | Gelatin | 0.6456 |
| | Ludox AM ™ (colloidal silica) | 0.1614 |
| | Polydimethylsiloxane (DC200 ™) | 0.0202 |
| | 5-chloro-2-methyl-4-isothiazolin-3-one/2- | 0.0001 |
| | methyl-4-isothiazolin-3-one(3/1) | |
| | SF-2 | 0.0032 |
| | Tergitol 15-S-5 ™ (surfactant) | 0.0020 |
| | SF-1 | 0.0081 |
| | Aerosol OT ™ (surfactant) | 0.0029 |

The 50.8 cm slit rolls of light sensitive silver halide emulsion coated on the polymer sheet of this example were printed using a digital laser photographic printer. Several test images that contained graphics, text, and images were printed. The printed images were then developed using standard reflective photographic RA-4 wet chemistry. At this point, the silver halide image was formed on a thin opaque polymer sheet containing a pressure sensitive adhesive. To further improve the durability of the developed image layers, an environmental protection layer was applied to the topmost gelatin layer in the developed imaging layers.

The environmental protection layer was prepared using 7.5 μm ground polymer particles (styrene butyl acrylate available from Hercules as Piccotoner 1221), a soft latex binder (copolymer of butyl acrylate, 2-acrylamido-2-methylpropanesulfonate, and acetoacetoxyethylmethacrylate) as a 20% suspension, a hydrophilic thickening agent (Keltrol T) as a 1% solution, and a surfactant (Olin 10G) as a 10% solution. The melt was hand-coated using a 3 mil coating knife to form a 547 mg/ft² gelatin pad hardened with bisvinylsulfonyl-methylether at 2.43%. After spreading, the coatings were dried at 30° C.

The structure of the imaged, printed, processed and protected imaging member of the invention was as follows: Fused styrene butyl acrylate environmental protection layer Developed silver halide imaging layers (yellow, magenta and cyan) Voided opaque polypropylene polymer sheet Acrylic pressure sensitive adhesive Silicone release layer Paper carrier sheet

The above imaging member was applied to several functional base materials listed in Table 1 below. The functional base materials provided a new utility of the image member.

TABLE 1

| Functional Base | New Image Utility |
|---|---|
| 200 thick micrometer polyester | Stiffness and rigidity |
| Polyester woven fabric with 3.7 | Cloth like texture |
| micrometer roughness average | |
| 400 micrometer thick foam board | Rigidity |
| 10 cm polmer cube | Multiple surface |
| 20 degree curved metal surface | Depth of image |
| 150 micrometer polyester with | Mounting to metallic display |
| magnetic strips | surfaces |

As the data above demonstrates, the functional bases of the invention significantly changed the utility of the image improve the image for commercial display applications which often require a new image utility for image durability, image display and image appearance. By pressure sensitive laminating the opaque high quality image member of the invention to unique functional base materials listed in table 1, the complexities to printing and processing these functional base materials in a silver halide process are removed. Further, only one opaque imaging member was required to create several differentiated product offerings creating savings for the commercial labs and allowing the commercial lab to utilize silver halide images in a unique fashion.

By applying the environmental protection layer to the silver halide imaging layers significantly improves the silver halide image toughness and allows the silver halide image to be used in demanding display applications such as outdoor display or theme park display, as the high humidity would destroy unprotected silver halide images. The silver halide image layers of the invention have also been optimized to accurately replicate flesh tones, providing superior images of people compared to alternate flexographic printing technologies.

While this example was directed towards silver halide printing of images, other high quality imaging techniques such as ink jet printing, thermal dye transfer printing and electrophotographic printing can be used in combination with the functional bases of the invention to create a new image utility. Further, while this example was directed toward commercial advertising, the invention materials can be used to improve the image utility for consumers and professionals alike. Examples include double sided prints, back illuminated wedding album images, photographic wallpaper and ink jet printed automobile interiors.

[image]

[image]

[image]

[image]

What is claimed is:

1. An article comprising an image member comprising a polymer sheet having an image adhered thereto permanently adhered to a functional base wherein said image member and said functional base interact to create a new image utility and wherein said polymer sheet has a thickness of less than 250 micrometers.

2. The article of claim 1 wherein said polymer sheet comprises an opaque sheet having a spectral transmission less than 20%.

3. The article of claim 1 wherein said polymer sheet comprises a clear sheet having a spectral transmission of greater than 90%.

4. The article of claim 1 wherein said polymer sheet comprises a translucent sheet having a spectral transmission of between 30 and 70%.

5. The article of claim 1 wherein said functional base comprises an electroluminescent member.

6. The article of claim 1 wherein said new image utility comprises a textured image.

7. The article of claim 1 wherein said new image utility comprises an optically-enhanced image.

8. The article of claim 1 wherein said new image utility comprises a structurally stronger image.

9. The article of claim 1 wherein said new image utility comprises an image having a three-dimensional shape.

10. The article of claim 1 wherein said new image utility comprises an image having a cloth-like surface.

11. The article of claim 1 wherein said new image utility comprises an image on cloth utilized as a window treatment.

12. The article of claim 1 wherein said new image utility comprises an image on wallpaper base.

13. The article of claim 1 wherein said new image utility comprises an image on rigid foam board.

14. The article of claim 1 wherein said functional base comprises a flooring.

15. The article of claim 1 wherein said functional base comprises a microembossed polymer.

16. The article of claim 1 wherein said functional base comprises a hologram.

17. The article of claim 1 wherein said functional base comprises an image and the image member comprises a transparent polymer sheet.

18. The article of claim 1 wherein said functional base comprises a metal.

19. The article of claim 1 wherein said functional base is magnetic.

20. The article of claim 1 wherein said functional base comprises a hook and loop fastening system.

21. The article of claim 1 wherein said functional base comprises a sail.

22. The article of claim 1 further comprising at least one further image member adhered to said article.

23. The article of claim 22 wherein said at least one further image member has a transparent base.

24. The article of claim 1 wherein said functional base comprises a colored surface and the image member comprises a transparent polymer sheet.

25. The article of claim 1 further comprising a second image member adhered to the opposite side of said functional base.

26. The article of claim 25 wherein said functional base comprises an optical diffuser.

27. The article of claim 1 wherein an adhesive is present on said image member prior to being permanently adhered to said frictional base.

28. The article of claim 1 wherein an adhesive is present on said functional base prior to being permanently adhered to said image member

29. The article of claim 1 where in said image comprises an image formed by photosensitive silver halide and dye forming couplers.

30. The article of claim 1 wherein said image comprises an image formed by inkjet.

31. The article of claim 1 wherein said image comprises an image formed by thermal dye transfer.

32. The article of claim 1 wherein said image comprises an image formed by electrophotography.

33. The article of claim 1 further comprising an environmental protection layer over said image.

34. The article of claim 1 wherein said image comprises an image formed by photosensitive silver halide and dye forming couplers and said article further comprises a second image member comprising an image formed by an inkjet image forming technique applied in the same plane as said image.
